(19) United States
(12) Patent Application Publication
(10) Pub. No.: US 2022/0337808 A1
(43) Pub. Date: Oct. 20, 2022

(54) INFORMATION PROCESSING APPARATUS FOR CALIBRATION PROCESSING OF COMMUNICATION WITH DETACHABLE DEVICE AND METHOD OF CONTROLLING THE SAME

(71) Applicant: CANON KABUSHIKI KAISHA, Tokyo (JP)

(72) Inventor: Tatsuya Watanabe, Chiba (JP)

(21) Appl. No.: 17/718,100

(22) Filed: Apr. 11, 2022

(30) Foreign Application Priority Data
Apr. 15, 2021 (JP) 2021-069267

(51) Int. Cl. H04N 17/00; H04N 5/232

(52) U.S. Cl. CPC H04N 17/002; H04N 5/23229

(57) ABSTRACT

An interface circuit is capable of attaching/detaching a detachable device. A control circuit is configured to perform calibration processing of communication with the detachable device via the interface circuit. The control circuit performs the calibration processing during a period when the detachable device is performing predetermined processing without communication via the interface circuit.

### BACKGROUND

### Technical Field

One disclosed aspect of the embodiments relates to communication connection with a detachable device.

### Description of the Related Art

In recent years, image analysis for detecting or tracking an object or estimating an attribute and image processing such as estimation of the number of objects based on the result of image analysis are performed in various scenes using images captured by a monitoring camera. Conventionally, image analysis has been performed by transferring videos from the monitoring camera to a high performance arithmetic apparatus such as a PC (Personal Computer) or a server. However, along with the improvement of the processing capability of mobile arithmetic apparatuses, a form in which image analysis is directly performed on the camera side is also used.

As an implementation form, not only a form that arranges an arithmetic apparatus in a camera main body but also a form that arranged an arithmetic apparatus in a detachable device connected via a USB (Universal Serial Bus) has been proposed. In a form in which arithmetic apparatuses are arranged in both a camera main body and a detachable device, more advanced analysis processing can be performed. If high-speed communication is performed between the camera and the detachable device, a calibration function for correcting electric characteristic degradation caused by an ambient temperature is often provided.

When performing image analysis, it is necessary to intermittently exchange image data or processing data between the camera and the detachable device. However, during calibration, data transfer for calibration occupies the channel between the camera and the detachable device, and other data cannot be transferred. For this reason, it is necessary to efficiently perform calibration without stopping image analysis. In addition, typical image processing operations may include image analysis techniques using a machine learning model trained to detect an object included in an image For example, a technique described in “J. Redmon and A. Farhadi, “YOLO9000: Better Faster Stronger”, Computer Vision and Pattern Recognition (CVPR) 2016” can be used.

Japanese Patent Laid-Open No. 2010-262025 (PTL 1) proposes a method of determining whether to perform calibration in accordance with the attribute (for example, a file format) of data to be transferred. In addition, Japanese Patent Laid-Open No. 2020-030521 (PTL 2) proposes a method in which a part of data is held at the time of data recording, and the data is compared when read out, thereby performing calibration without narrowing the band of communication.

In the technique described in PTL 1, however, in a configuration that needs to cope with a plurality of data formats on a detachable device, it is impossible to determine the necessity of calibration. In the technique described in PTL 2, data written to a detachable device and data read out from the detachable device need to be the same. It is therefore impossible to apply the technique to a configuration for reading out a result of arithmetic processing performed in the detachable device.

### SUMMARY

According to one aspect of the embodiments, an information processing apparatus includes an interface circuit and a control circuit. The interface circuit is capable of attaching/detaching a detachable device. The control circuit is configured to perform calibration processing of communication with the detachable device via the interface circuit. The control circuit performs the calibration processing during a period when the detachable device is performing predetermined processing without communication via the interface circuit.

One aspect of the embodiments enables more suitable calibration processing.

Further features of the disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram showing the overall configuration of an image analysis system;

FIG. 2 is a block diagram showing the hardware configuration of an image capturing apparatus;

FIG. 3 is a block diagram showing the functional configuration of the image capturing apparatus;

FIG. 4 is a block diagram showing the hardware configuration of a detachable device;

FIG. 5 is a block diagram showing the functional configuration of the detachable device;

FIG. 6 is a block diagram showing the hardware configuration of an input/output apparatus;

FIG. 7 is a block diagram showing the functional configuration of the input/output apparatus;

FIG. 8 is a flowchart of processing performed by the system;

FIG. 9 is a sequence chart of calibration processing;

FIGS. 10A and 10B are views for explaining delay adjustment at the receiving end of the image capturing apparatus;

FIG. 11 is a view for explaining determination of a delay value based on an error determination result;

FIG. 12 is a sequence chart of arithmetic processing;

FIGS. 13A and 13B are a sequence chart when divisionally performing calibration processing; and

FIGS. 14A and 14B are views for explaining thinning processing of delay value patterns.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted. In the following, the term “unit” may be used to refer to a circuit, a subsystem, a module, a functional block, a logic device, a physical device, a processor, or hardware elements. It may include mechanical, optical, or electrical components, or any combination of them. It may include active (e.g., transistors) or passive (e.g., capacitors) components. It may include one or more programmable processors, such as a central processing unit (CPU) or a microprocessor, that are configured to execute instructions or programs stored in one or more memory devices to perform specified operations. It may include logic elements such as AND-OR, and NOT elements implemented by transistor circuits or any other switching circuits. Typical combinational logic functions may be implemented by switching circuits such as multiplexers (to implement select functions), encoders, and decoders.

### First Embodiment

As the first embodiment of an information processing apparatus, an image analysis system will be described below as an example.

<Overall System Configuration>

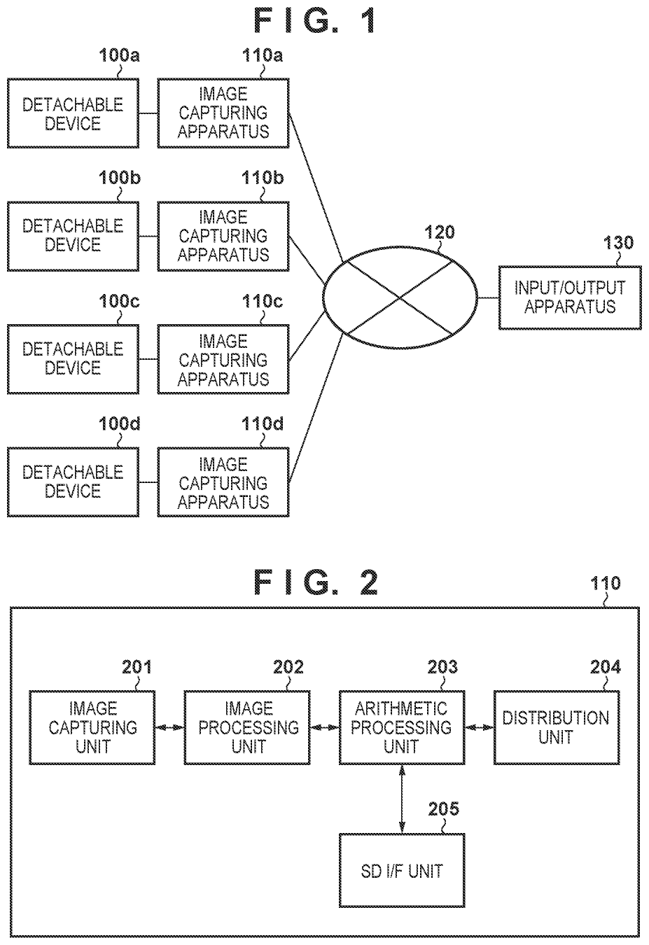

FIG. 1 is a block diagram showing the overall configuration of an image analysis system. As an example, a case in which this system is a specific person tracking system will be described below. However, the disclosure is not limited to this, and the following argument can be applied to an arbitrary system for analyzing an image and performing predetermined information output. This system is configured to include image capturing apparatuses 110a to 110d, a network 120, and an input/output apparatus 130. Note that the image capturing apparatuses 110a to 110d each include a slot to/from which a device capable of recording, for example, a captured image can be attached/detached, and when detachable devices 100a to 100d are inserted into the slots, the image capturing apparatuses 110a to 110d are connected to the detachable devices 100a to 100d. Note that the detachable devices 100a to 100d will be referred to as “detachable devices 100”, and the image capturing apparatuses 110a to 110d will be referred to as “image capturing apparatuses 110” hereinafter.

The detachable device 100 is an arithmetic device attachable/detachable to/from the image capturing apparatus 110. As an example, the detachable device 100 is a device with a predetermined processing circuit mounted in an SD (Secure Digital) card. The detachable device 100 is configured to be inserted as a whole into the image capturing apparatus 110 in a form of, for example, an SD card, and can therefore be configured to be connectable to the image capturing apparatus 110 without making any portion project from the image capturing apparatus 110. This can prevent the detachable device 100 from interfering with an obstacle such as a wiring and raise the convenience when using the device. In addition, since an SD card slot is prepared in a lot of existing image capturing apparatuses 110 such as a network camera, the detachable device 100 can provide an extension function to the existing image capturing apparatus 110. Note that other than the form of an SD card, the detachable device 100 may be configured to be mounted in the image capturing apparatus 110 via an arbitrary interface used when mounting a storage device capable of storing an image captured by at least the image capturing apparatus 110. For example, the detachable device 100 may include a USB (Universal Serial Bus) interface, and may be configured to be mounted in a USB socket of the image capturing apparatus 110. The predetermined processing circuit is implemented by, for example, an FPGA (Field Programmable Gate Array) programmed to perform predetermined processing but may be implemented in another form.

The image capturing apparatus 110 is an image capturing apparatus such as a network camera. In this embodiment, the image capturing apparatus 110 incorporates an arithmetic apparatus capable of processing a video but is not limited to this. For example, an external computer such as a PC (Personal Computer) connected to the image capturing apparatus 110 may exist, and the combination may be handled as the image capturing apparatus 110. Additionally, in this embodiment, the detachable devices 100 are mounted in all the image capturing apparatuses 110. Note that FIG. 1 shows four image capturing apparatuses 110, and the detachable devices mounted in these. The number of combinations of devices may be three or less, or five or more. When the detachable device 100 having an image analysis processing function is mounted in the image capturing apparatus 110, video processing can be performed on the side of the image capturing apparatus 110 even if the image capturing apparatus 110 does not have the image analysis processing function. Also, in a form in which an arithmetic apparatus for video processing is arranged in the image capturing apparatus 110, as in this embodiment, image processing performable on the side of the image capturing apparatus 110 can be diversified/sophisticated by mounting the detachable device 100 including an arithmetic apparatus in the image capturing apparatus 110.

The input/output apparatus 130 is an apparatus that performs acceptance of input from a user and output of information (for example, display of information) to the user. In this embodiment, for example, the input/output apparatus 130 is a computer such as a PC, and information is input/output by a browser or a native application installed in the computer.

The image capturing apparatuses 110 and the input/output apparatus 130 are communicably connected via the network 120. The network 120 is configured to include a plurality of routers, switches, cables, and the like, which satisfy the communication standard of, for example, Ethernet®. In this embodiment, the network 120 can be an arbitrary network that enables communication between the image capturing apparatus 110 and the input/output apparatus 130, and can be constructed by an arbitrary scale and configuration and a communication standard to comply with. For example, the network 120 can be the Internet, a wired LAN (Local Area Network), a wireless LAN, a WAN (Wide Area Network), or the like. The network 120 can be configured such that, for example, communication by a communication protocol complying with the ONVIF (Open Network Video Interface Forum) standard is possible. However, the network 120 is not limited to this and may be configured such that, for example, communication by another communication protocol such as a unique communication protocol is possible.

<Configuration of Image Capturing Apparatus>

FIG. 2 is a block diagram showing the hardware configuration of the image capturing apparatus 110. As the hardware configuration, the image capturing apparatus 110 includes, for example, an image capturing unit or circuit 201, an image processing unit or circuit 202, an arithmetic processing unit or circuit 203, a distribution unit or circuit 204, and an SD I/F unit or circuit 205. Note that I/F is an abbreviation of interface.

The image capturing unit 201 is configured to include a lens portion configured to form an image of light, and an image capturing element that performs analog signal conversion according to the formed image of light. The lens portion has a zoom function of adjusting an angle of view, a stop function of adjusting a light amount, and the like. The image capturing element has a gain function of adjusting sensitivity when converting light into an analog signal. These functions are adjusted based on set values notified from the image processing unit 202. The analog signal obtained by the image capturing unit 201 is converted into a digital signal by an analog-to-digital conversion circuit and transferred to the image processing unit 202 as an image signal.

The image processing unit 202 is configured to include an image processing engine, and peripheral devices thereof. The peripheral devices include, for example, a RAM (Random Access Memory), the drivers of I/Fs, and the like. The image processing unit 202 performs, for example, image processing such as development processing, filter processing, sensor correction, and noise removal for the image signal obtained from the image capturing unit 201, thereby generating image data. The image processing unit 202 can also transmit set values to the lens portion and the image capturing element and perform exposure adjustment to obtain an appropriately exposed image. The image data generated by the image processing unit 202 is transferred to the arithmetic processing unit 203.

The arithmetic processing unit 203 is formed by at least one processor such as a CPU or an MPU, memories such as a RAM and a ROM, the drivers of I/Fs, and the like. Note that CPU is the acronym of Central Processing Unit, MPU is the acronym of Micro Processing Unit, RAM is the acronym of Random Access Memory, and ROM is the acronym of Read Only Memory. In an example, the arithmetic processing unit 203 can determine allocation concerning which one of the image capturing apparatus 110 and the detachable device 100 should perform each portion of processing to be performed in the above-described system, and perform processing corresponding to the allocation. The image received from the image processing unit 202 is transferred to the distribution unit 204 or the SD I/F unit 205. The data of the processing result is also transferred to the distribution unit 204.

The distribution unit 204 is configured to include a network distribution engine and, for example, peripheral devices such as a RAM and an ETH PHY (Ethernet Physical) module. The ETH PHY module is a module that perform processing of the physical (PHY) layer of Ethernet. The distribution unit 204 converts the image data or the data of the processing result obtained from the arithmetic processing unit 203 into a format distributable to the network 120, and outputs the converted data to the network 120.

The SD I/F unit 205 is an interface portion used to connect the detachable device 100, and is configured to include, for example, a power supply, and a mounting part such as an attaching/detaching socket used to attach/detach the detachable device 100. Here, the SD I/F unit 205 is configured in accordance with the SD standard formulated by the SD Association. Communication between the detachable device 100 and the image capturing apparatus 110, such as transfer of an image obtained from the arithmetic processing unit 203 to the detachable device 100 or data obtaining from the detachable device 100, is performed via the SD I/F unit 205.

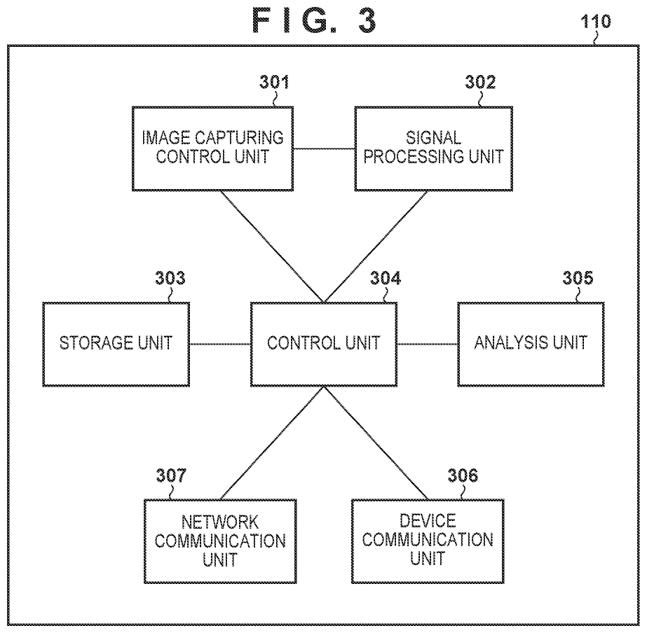

FIG. 3 is a block diagram showing the functional configuration of the image capturing apparatus 110. The image capturing apparatus 110 includes, as its functions, for example, an image capturing control unit 301, a signal processing unit 302, a storage unit 303, a control unit 304, an analysis unit 305, a device communication unit 306, and a network communication unit 307.

The image capturing control unit 301 performs control of capturing the peripheral environment via the image capturing unit 201. The signal processing unit 302 performs predetermined processing for the image captured by the image capturing control unit 301, thereby generating data of the captured image. The data of the captured image will simply be referred to as the “captured image” hereinafter. The signal processing unit 302, for example, encodes the image captured by the image capturing control unit 301. The signal processing unit 302 performs encoding for a still image using, for example, an encoding method such as JPEG (Joint Photographic Experts Group). The signal processing unit 302 performs encoding for a moving image using an encoding method such as H.264/MPEG-4 AVC (to be referred to as “H.264” hereinafter) or HEVC (High Efficiency Video Coding). The signal processing unit 302 may encode an image using an encoding method selected by the user from a plurality of encoding methods set in advance via, for example, an operation unit (not shown) of the image capturing apparatus 110.

The storage unit 303 stores a list (to be referred to as a “first processing list” hereinafter) of analysis processing performable by the analysis unit 305 and a list of post-processes for a result of analysis processing. The storage unit 303 also stores a result of analysis processing to be described later. Note that in this embodiment, processing to be performed is analysis processing. However, arbitrary processing may be performed, and concerning processing associated with the processing to be performed, the storage unit 303 may store the first processing list and the list of post-processes. The control unit 304 controls the signal processing unit 302, the storage unit 303, the analysis unit 305, the device communication unit 306, and the network communication unit 307 to perform predetermined processing.

The analysis unit 305 selectively performs at least one of pre-analysis processing, analysis processing, and post-analysis processing to be described later for a captured image. Pre-analysis processing is processing to be performed for a captured image before analysis processing to be described later is performed. In the pre-analysis processing according to this embodiment, as an example, processing of dividing a captured image to create divided images is performed. Analysis processing is processing of outputting information obtained by analyzing an input image. In the analysis processing according to this embodiment, as an example, processing of receiving a divided image obtained by pre-analysis processing, performing at least one of human body detection processing, face detection processing, and vehicle detection processing, and outputting the analysis processing result is performed. The analysis processing can be processing configured to output the position of an object in a divided image using a machine learning model trained to detect an object included in an image. Post-analysis processing is processing to be performed after analysis processing is performed. In the post-analysis processing according to this embodiment, as an example, processing of outputting, as a processing result, a value obtained by adding the numbers of objects detected in the divided images based on the analysis processing result for each divided image is performed. Note that the analysis processing may be processing of detecting an object in an image by performing pattern matching and outputting the position of the object.

The device communication unit 306 performs communication with the detachable device 100. The device communication unit 306 converts input data into a format processible by the detachable device 100, and transmits data obtained by the conversion to the detachable device 100. In addition, the device communication unit 306 receives data from the detachable device 100, and converts the received data into a format processible by the image capturing apparatus 110. In this embodiment, as the conversion processing, the device communication unit 306 performs processing of converting a decimal between a floating point format and a fixed point format. However, the disclosure is not limited to this, and another processing may be performed by the device communication unit 306. Additionally, in this embodiment, the device communication unit 306 transmits a command sequence determined in advance within the range of the SD standard to the detachable device 100, and receives a response from the detachable device 100, thereby performing communication with the detachable device 100. The network communication unit 307 performs communication with the input/output apparatus 130 via the network 120.

<Configuration of Detachable Device>

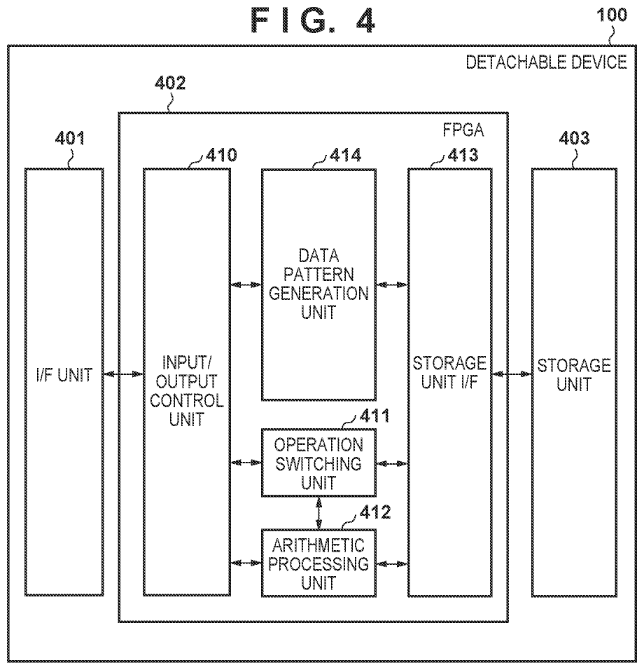

FIG. 4 is a block diagram showing the hardware configuration of the detachable device 100. As an example, the detachable device 100 is configured to include an I/F unit 401, an FPGA 402, and a storage unit 403. The detachable device 100 is formed into a shape that can be inserted/removed into/from the attaching/detaching socket of the SD I/F unit 205 provided in the image capturing apparatus 110, that is, a shape complying with the SD standard.

The I/F unit 401 is an interface portion used to connect an apparatus such as the image capturing apparatus 110 and the detachable device 100. The I/F unit 401 is configured to include, for example, an electrical contact terminal that receives supply of power from the image capturing apparatus 110 and generates and distributes a power supply to be used in the detachable device 100, and the like. Concerning items defined in (complying with) the SD standard, the I/F unit 401 complies with that, like the SD I/F unit 205 of the image capturing apparatus 110. Reception of images and setting data from the image capturing apparatus 110 and transmission of data from the FPGA 402 to the image capturing apparatus 110 are performed via the I/F unit 401.

The FPGA 402 is configured to include an input/output control unit 410, an operation switching unit 411, an arithmetic processing unit 412, a storage unit I/F 413, and a data pattern generation unit 414. The FPGA 402 is a kind of semiconductor device capable of repetitively reconfiguring an internal logic circuit structure. By a circuit configured on the FPGA 402, a processing function can be added (provided) to the apparatus in which the detachable device 100 is mounted. Additionally, since the logic circuit structure can be changed later by the reconfiguration function of the FPGA 402, when the detachable device 100 is mounted in, for example, an apparatus in a field of a quickly advancing technology, appropriate processing can be performed in the apparatus at an appropriate timing. Note that in this embodiment, an example in which an FPGA is used will be described. However, for example, a general-purpose ASIC (Application Specific Integrated Circuit) or a dedicated LSI (Large Scale Integration) circuit may be used if processing to be described later can be implemented.

The FPGA 402 is activated by writing, from a dedicated I/F, setting data including the information of a logic circuit structure to be generated or reading out the setting data from the dedicated I/F. In this embodiment, the setting data is held in the storage unit 403. When powered on, the FPGA 402 reads out the setting data from the storage unit 403 and generates and activates a logic circuit. However, the disclosure is not limited to this. For example, the image capturing apparatus 110 may write the setting data in the FPGA 402 via the I/F unit 401 by implementing a dedicated circuit in the detachable device.

The input/output control unit 410 is configured to include a circuit used to transmit/receive an image to/from the image capturing apparatus 110, a circuit that analyzes a command received from the image capturing apparatus 110, a circuit that controls based on a result of analysis, and the like. Commands here are defined by the SD standard, and the input/output control unit 410 can detect some of them. In image analysis processing, the input/output control unit 410 transmits an image to the arithmetic processing unit 412. In processing of rewriting data held by the storage unit 403, the input/output control unit 410 controls to transmit data to the storage unit I/F 413. If the setting data of switching of processing is received, the input/output control unit 410 transmits the setting data to the operation switching unit 411. If an instruction for performing calibration is received, the input/output control unit 410 requests output data from the data pattern generation unit 414.

The operation switching unit 411 is configured to include a circuit configured to obtain the information of the image analysis processing function from the storage unit 403 based on the setting data received from the image capturing apparatus 110 and write the information in the arithmetic processing unit 412. The information of the image analysis processing function includes setting parameters representing, for example, the order and types of operations processed in the arithmetic processing unit 412, the coefficients of operations, and the like.

The arithmetic processing unit 412 is configured to include a plurality of arithmetic circuits needed to perform the image analysis processing function. The arithmetic processing unit 412 performs each arithmetic processing based on the information of the image analysis processing function received from the operation switching unit 411, transmits the processing result to the image capturing apparatus 110, or records the processing result in the storage unit 403.

The data pattern generation unit 414 transmits fixed pattern data for calibration in response to the output data request received from the input/output control unit 410. The fixed pattern data may be a fixed pattern defined by the SD standard or may be a unique pattern as long as it is data known by the image capturing apparatus 110. The fixed pattern data may be held in the FPGA 402, or fixed pattern data held in the storage unit 403 may be read out. In the latter case, the data pattern generation unit 414 issues an instruction to read out fixed pattern data stored at a predetermined address of the storage unit I/F 413.

The storage unit 403 is formed by, for example, a NOR flash memory, and stores various kinds of information such as storage data written from the image capturing apparatus 110, the information of the image analysis processing function written in the arithmetic processing unit 412, and configuration data of the FPGA 402.

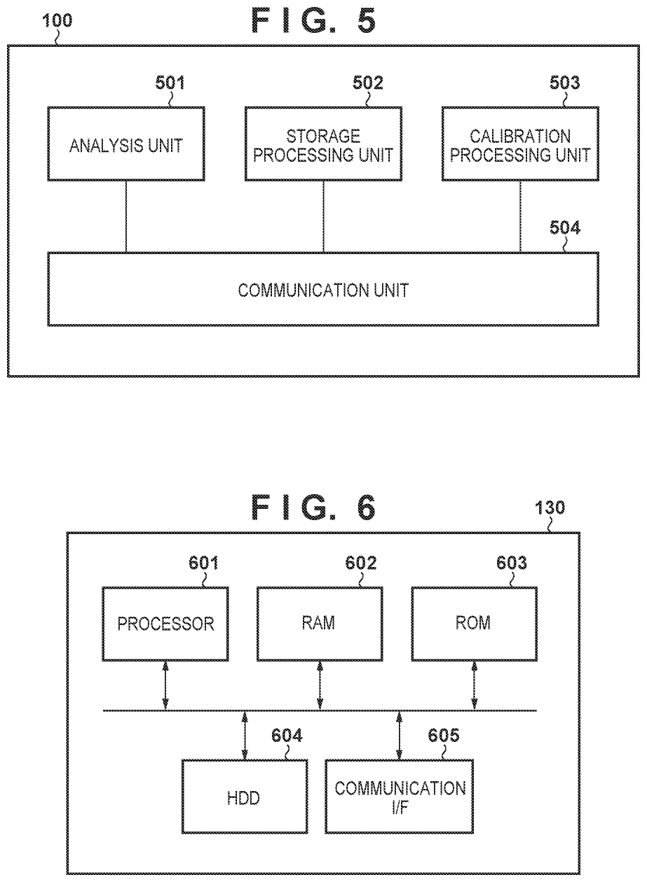

FIG. 5 is a block diagram showing the functional configuration of the detachable device 100. The detachable device 100 includes, as its functional configuration, for example, an analysis unit 501, a storage processing unit 502, a calibration processing unit 503, and a communication unit 504.

The analysis unit 501 performs analysis processing for an image. For example, if an analysis processing setting request is input, the analysis unit 501 performs setting to set the input analysis processing in a performable state. If an image is input, the analysis unit 501 performs the analysis processing set in the performable state for the input image. Performable analysis processing can be applied to both image analysis processing using machine learning and image analysis processing without using machine learning. Each analysis processing described above may be performed not independently by the detachable device 100 but in cooperation with the image capturing apparatus 110.

The storage processing unit 502 performs readout and rewrite processing of data held in the storage unit 403. For example, if a rewrite request for the information of the image analysis processing function is input, the storage processing unit 502 writes data received from the image capturing apparatus 110 at a designated address of the storage unit 403. A detailed sequence of rewrite will be described later. The calibration processing unit 503 outputs a data pattern for calibration based on a calibration instruction received from the image capturing apparatus 110. The communication unit 504 performs communication with the image capturing apparatus 110 via the I/F unit 401 in accordance with a protocol complying with the SD standard.

<Configuration of Input/Output Apparatus>

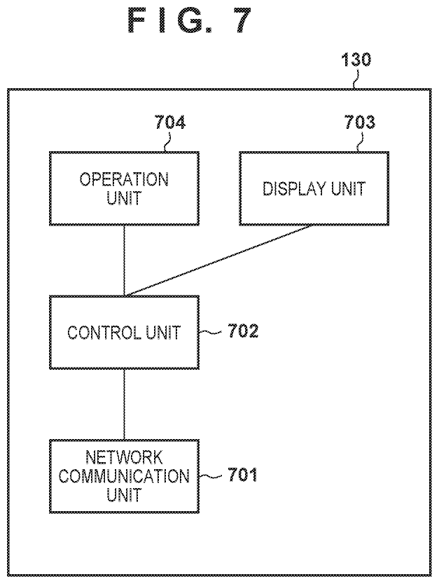

FIG. 6 is a block diagram showing the hardware configuration of the input/output apparatus 130. The input/output apparatus 130 is formed as a computer such as a general PC, and is configured to include, for example, a processor 601 such as a CPU, memories such as a RAM 602 and a ROM 603, a storage device such as an HDD (Hard Disk Drive) 604, and a communication I/F 605, as shown in FIG. 6. The input/output apparatus 130 can perform various kinds of functions by performing, by the processor 601, programs stored in the memories and the storage device.

FIG. 7 is a block diagram showing the functional configuration of the input/output apparatus 130. The input/output apparatus 130 includes, as its functional configuration, for example, a network communication unit 701, a control unit 702, a display unit 703, and an operation unit 704. The network communication unit 701 is connected to, for example, the network 120 and performs communication with an external apparatus such as the image capturing apparatus 110 via the network 120. Note that this is merely an example and, for example, the network communication unit 701 may be configured to establish direct communication with the image capturing apparatus 110 and communicate with the image capturing apparatus 110 without intervention of the network 120 or other apparatus. The control unit 702 controls such that the network communication unit 701, the display unit 703, and the operation unit 704 performs processing of their own. The display unit 703 presents information to the user via, for example, a display. In this embodiment, a result of rendering by a browser is displayed on a display, thereby presenting information to the user. Note that information may be presented by a method such as an audio or a vibration other than screen display. The operation unit 704 accepts an operation from the user. In this embodiment, the operation unit 704 is a mouse or a keyboard, and the user operates these to input a user operation to the browser. However, the operation unit 704 is not limited to this and may be, for example, another arbitrary device capable of detecting a user's intention, such as a touch panel or a microphone.

<Operation of System>

An example of the procedure of processing performed in the system will be described next. Note that processing performed by the image capturing apparatus 110 in the following processes is implemented by, for example, by a processor in the arithmetic processing unit 203, performing a program stored in a memory or the like. However, this is merely an example, and processing to be described later may partially or wholly be implemented by dedicated hardware. In addition, processing performed by the detachable device 100 or the input/output apparatus 130 may also be implemented by, by a processor in each apparatus, performing a program stored in a memory or the like, and processing may partially or wholly be implemented by dedicated hardware.

<Overall Operation of Image Analysis Processing>

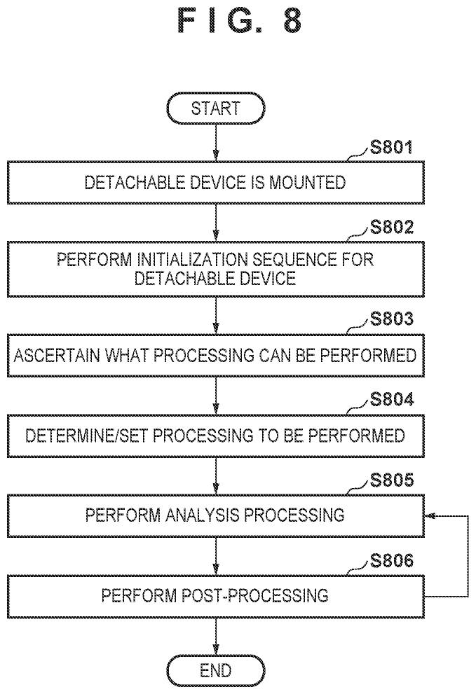

FIG. 8 is a flowchart of processing performed by the system. In step S801, the detachable device 100 is mounted in the image capturing apparatus 110 (by, for example, the user).

In step S802, the image capturing apparatus 110 performs an initialization sequence for the detachable device 100. In this initialization sequence, predetermined commands are transmitted/received between the image capturing apparatus 110 and the detachable device 100, and the image capturing apparatus 110 is thus set in a state in which it can use the detachable device 100.

In step S803, the image capturing apparatus 110 ascertains what processing can be performed by the detachable device 100, and ascertains what processing can be performed (that can be performed only by the image capturing apparatus 110 or by the combination of the image capturing apparatus 110 and the detachable device 100). Note that although the detachable device 100 can be configured to perform arbitrary processing, processing irrelevant to processing that should be performed on the side of the image capturing apparatus 110 need not be taken into consideration.

In an example, the image capturing apparatus 110 may hold a list of performable processes, which is obtained in advance from, for example, the input/output apparatus 130. In this case, when obtaining, from the detachable device 100, information representing processing performable by the detachable device 100, the image capturing apparatus 110 can ascertain what processing can be performed by the detachable device 100 depending on whether the processing is included in the list.

In step S804, the image capturing apparatus 110 determines processing to be performed by each of the image capturing apparatus 110 and the detachable device 100, and performs setting of the detachable device 100 as needed. That is, if at least part of processing determined as a performing target is to be performed by the detachable device 100, setting of the detachable device 100 for the processing is performed. In this setting, for example, reconfiguration of the FPGA 402 using setting data corresponding to the processing of the performing target can be performed.

In step S805, the image capturing apparatus 110 and/or the detachable device 100 performs analysis processing. In step S806, the image capturing apparatus 110 performs post-processing. Note that the processes of steps S805 and S806 are repetitively performed.

The processing shown in FIG. 8 is performed when, for example, the detachable device 100 is mounted. However, at least part of the processing shown in FIG. 8 may repetitively be performed such that, for example, the process of step S803 is performed again when the detachable device 100 is detached.

<Calibration Operation>

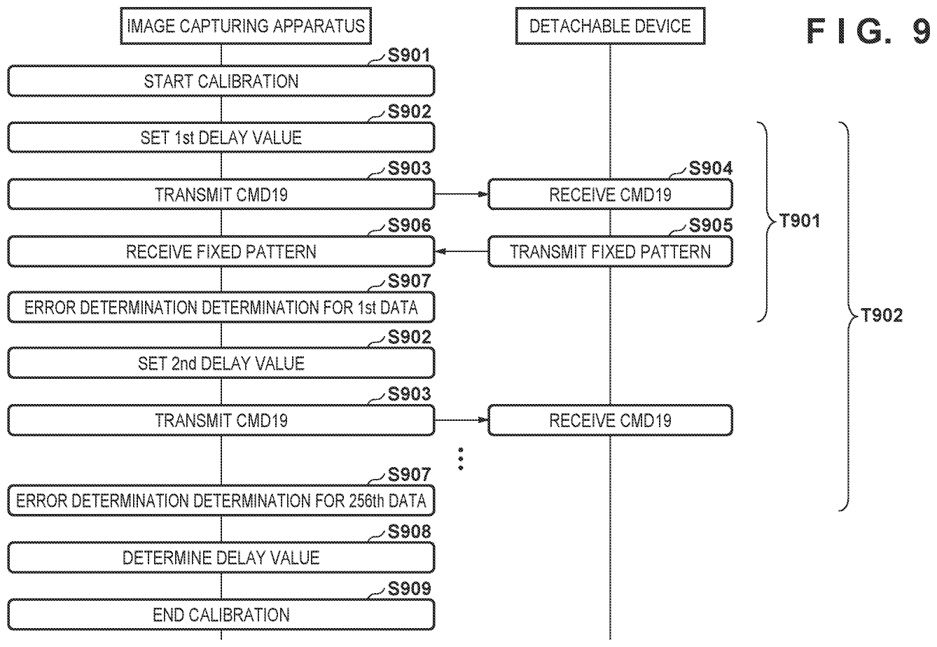

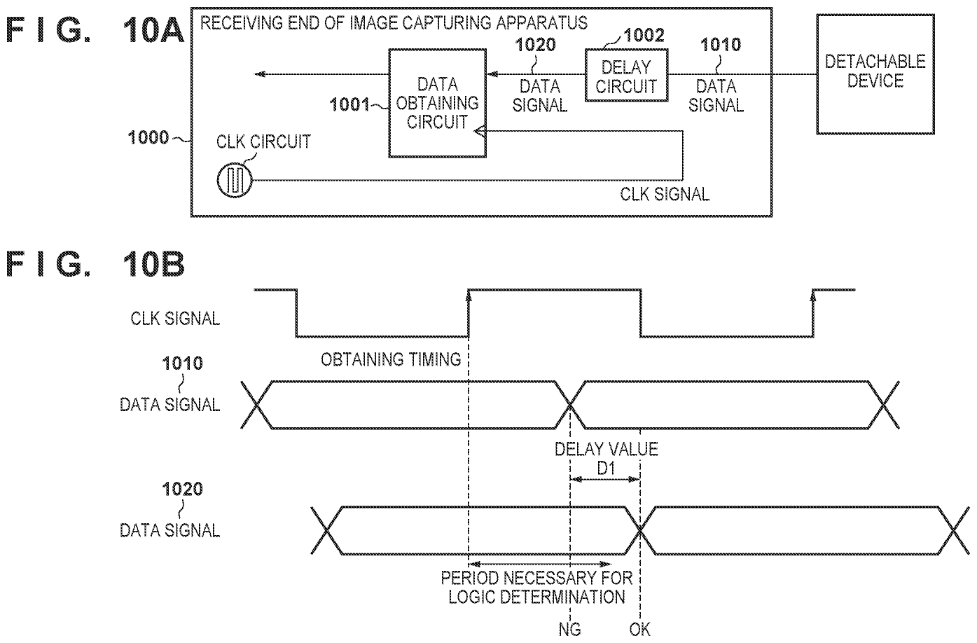

The mechanism of a calibration sequence will be described with reference to FIGS. 9, 10A, and 10B. In general, calibration means comparing a plurality of values and adjusting these. In this embodiment, calibration means adjusting, for a certain signal, the phase relationship of another signal. More specifically, on the side of the image capturing apparatus 110, the obtaining timing of a data signal (DATA) or a command signal (CMD) is shifted with respect to a clock signal (CLK), thereby adjusting the phase relationship. The shift amount of the obtaining timing will be referred to as a delay value hereinafter.

FIGS. 10A and 10B are views for explaining delay adjustment at a receiving end 1000 of the image capturing apparatus 110. FIG. 10A shows the circuit at the receiving end of the image capturing apparatus 110, and FIG. 10B shows a state in which the phase relationship between a plurality of signals is adjusted.

A DATA signal 1010 received from the detachable device 100 passes through a delay circuit 1002 and is given a delay value D1 and input to a data obtaining circuit 1001 synchronized with a CLK signal. The range of the value that can be set as the delay value is determined by the configuration of the delay circuit 1002. An arrow of the CLK signal indicates a data obtaining timing. In a general digital circuit, to determine the logic, it is necessary to prevent the DATA signal from changing for a predetermined period before and after the obtaining timing. In FIG. 10B, when the delay value D1 is given, the data obtaining circuit 1001 can ensure the period necessary for logic determination and obtain an expected value.

FIG. 9 is a sequence chart of calibration processing. In step S901, if a condition that the image capturing apparatus 110 performs calibration is satisfied, the sequence starts. The condition to start calibration will be described later.

In step S902, the delay circuit 1002 sets the delay value. In this embodiment, the delay circuit 1002 sets the delay value by selecting one of M (here, M=256) adjustment values (delay values) which are different by a predetermined delay amount (AT). For example, the delay value D1=n×ΔT (n is an integer of 0 to 255), and the delay value is selected sequentially from n=0.

In step S903, the image capturing apparatus 110 transmits CMD19 to the detachable device 100. CMD19 is a command defined on the SD standard, and, in this embodiment, is used to instruct the detachable device 100 to output fixed pattern data for calibration. Here, the fixed pattern data for calibration is data known by the image capturing apparatus 110.

In step S904, the detachable device 100 that has received the CMD19 sets the fixed pattern data for calibration processing, which is to be transmitted to the image capturing apparatus 110, in the FPGA 402 or the storage unit 403 to prepare for transmission.

In step S905, the detachable device 100 starts transmitting the fixed pattern data to the image capturing apparatus 110. In step S906, the image capturing apparatus 110 receives the data while giving the delay value set in step S902 to the DATA signal. In step S907, the image capturing apparatus 110 compares the received data with an expected value (known pattern data), and perform data reception error determination for the received data. From then on, the processes of steps S902 to S907 are repetitively performed for the remaining delay values. Here, time (T901) from step S902 to step S907 can be estimated as follows.

T901=fixed pattern data size [Byte]×CLK signal period [ns]÷transfer bit width [bit]/8 [bit] (1)

For example, if the size of the fixed pattern data is 64 Bytes, the period of the CLK signal is 10 nanoseconds (ns), and the transfer bit width is 4 bits, T901 is 1.28 microseconds (μs).

For this reason, time (T902) necessary for calibration can be estimated as follows.

T902=T901 [μs]×256 [times] (2)

In this example, T902 is 327.68 μs.

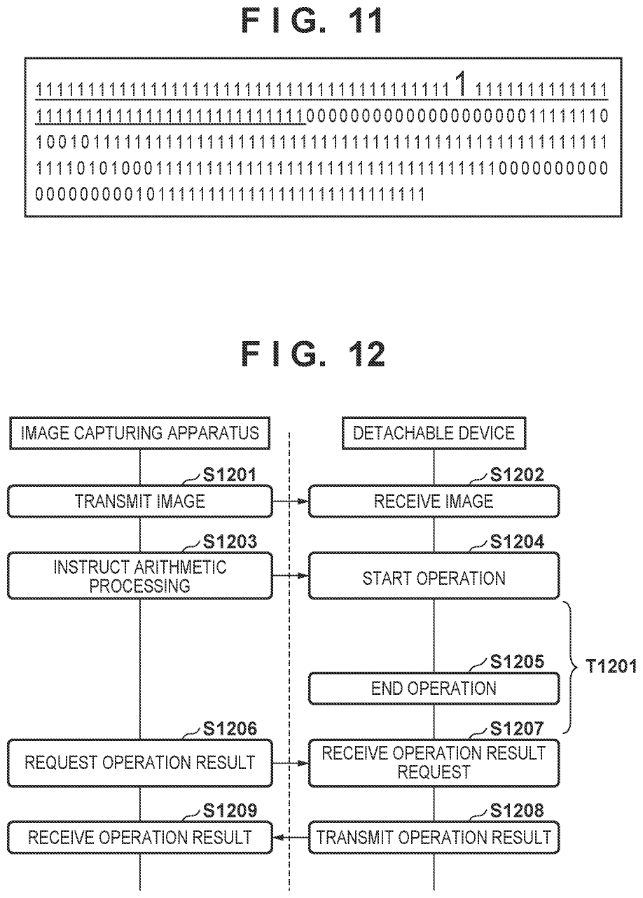

In step S908, the image capturing apparatus 110 determines the delay value based on error determination of all delay value patterns. FIG. 11 is a view for explaining determination of a delay value based on an error determination result. In FIG. 11, as the result of error determination for 256 delay values, “correct (no error exists)” is represented by “1”, and “wrong (error exists)” is represented by “0”. The image capturing apparatus 110 determines the delay value based on the delay value corresponding to the center (“1” shown large) of a portion where “1” continues longest (a portion indicated by an underline). In the case of the result shown in FIG. 11, the delay value is determined to the 41st delay value. After that, in step S909, the image capturing apparatus 110 ends the calibration sequence.

<Calibration Start Conditions>

As the conditions to start calibration processing (advance to step S901), for example, the following three conditions are used.

Condition 1: a communication error occurs during communication between the image capturing apparatus 110 and the detachable device 100. That is, if the image capturing apparatus 110 detects an error based on a CRC (Cyclic Redundancy Check) function defined on the SD standard or timeout of communication, calibration is started.

Condition 2: a temperature change of a predetermined amount or more is detected by a temperature sensor. If the temperature sensor is implemented on the image capturing apparatus 110 or the detachable device 100, the arithmetic processing unit 203 obtains temperature information from the temperature sensor, corrects the temperature information based on the position relationship between the temperature sensor and the SD I/F unit 205, and calculates the temperature of the SD I/F unit 205. For example, this temperature is compared with a previously obtained temperature. If a change amount per time is a change of a predetermined amount or more, calibration is started.

Condition 3: the arithmetic processing period of the detachable device 100 continues for a predetermined time or more. In the processes performed by the detachable device 100, power consumption becomes highest during arithmetic processing. Hence, processing time information concerning arithmetic processing is obtained from the detachable device 100. If the time is a predetermined time or more, calibration is started after a series of arithmetic processes.

<Division of Calibration Processing>

As described above, in calibration processing, error determination needs to be performed for many delay values (256 delay values in the above-described case). Hence, a relatively long time is needed to perform calibration processing (327.68 μs in the above-described case). This may affect the arithmetic processing in the image capturing apparatus 110 or the detachable device 100. It is therefore preferable to divide calibration processing in accordance with the situation.

FIG. 12 is a sequence chart of arithmetic processing in a case in which the calibration sequence shown in FIG. 9 can be performed at once. As described above, calibration is processing for correcting an electric characteristic in a certain temperature change. Since the temperature is an always changing value, from the viewpoint of the purpose of calibration, it is optimum to perform calibration in a short period when the condition to perform calibration is satisfied. Hence, the pattern of calibration to be described in this section is the basic calibration in this embodiment.

In step S1201, the image capturing apparatus 110 transmits image data to be used in arithmetic processing to the detachable device 100. In step S1202, the detachable device 100 stores the received image data in an area for operation.

In step S1203, the image capturing apparatus 110 sends an arithmetic processing start instruction to the detachable device 100 after the image data transmission. In step S1204, the detachable device 100 that has received the arithmetic processing instruction starts arithmetic processing for the data stored in the area for operation. In step S1205, the detachable device 100 performs an operation based on the information of the image analysis processing function held in the storage unit 403, and stores the result in the area for operation result.

In step S1206, the image capturing apparatus 110 stands by for a predetermined period after instructing arithmetic processing, and requests the operation result from the detachable device 100. In step S1207, the detachable device 100 that has received the operation result request prepares transmission of the operation result from the area for operation result. In step S1208, after that, the detachable device 100 transmits the prepared operation result data to the image capturing apparatus 110. In step S1209, the image capturing apparatus 110 receives the operation result, and the sequence is completed.

Note that a broken line shown in FIG. 12 indicates the interface between the image capturing apparatus 110 and the detachable device 100, and a solid arrow indicates that communication is performed at a timing across the broken line.

T1201 (the operation period from step S1204 to step S1207) indicates a period when communication is not being performed. T1201 is determined by the contents to arithmetic processing to be performed, the size of the input image data, and the like. If T1201>T902, the calibration processing shown in FIG. 9 can be performed at once after the processing of step S1203.

Although details will be omitted, an example other than the arithmetic processing performed on the detachable device described above is a storage unit rewrite sequence for rewriting data in the storage unit 403 on the detachable device 100 from the image capturing apparatus 110. In the storage unit rewrite sequence, since write and deletion of a target address portion in the storage unit are performed as a set, the above-described period T1201 is on the order of “second”. For this reason, this corresponds to a case in which the calibration sequence shown in FIG. 12 can be performed at once.

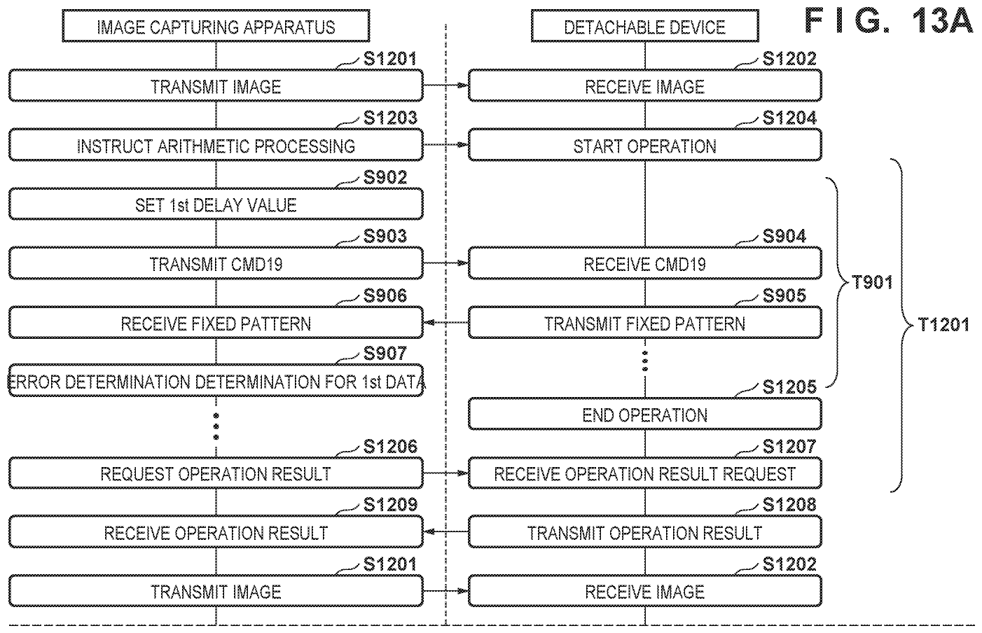

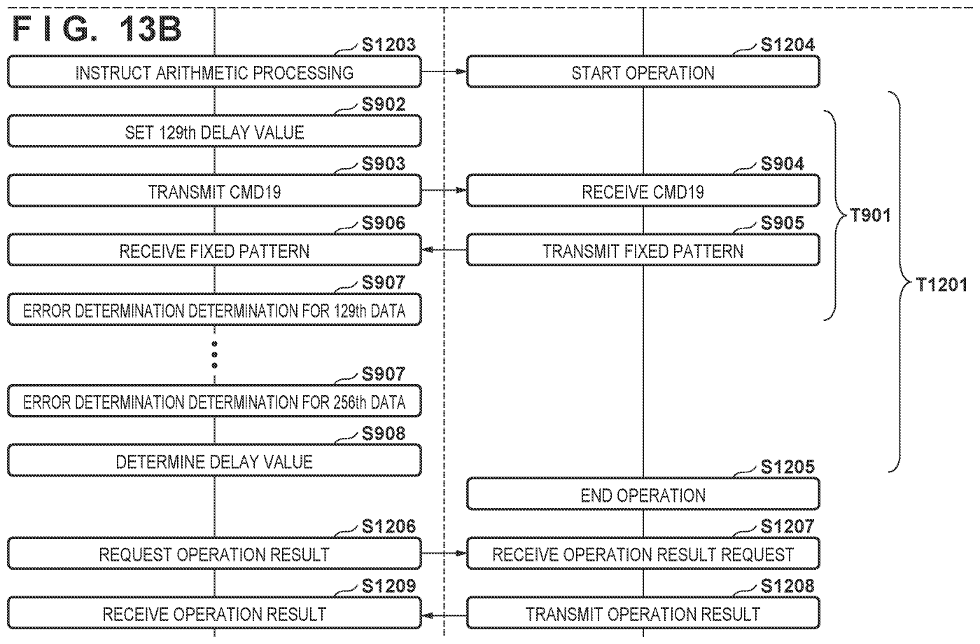

FIGS. 13A and 13B are a sequence chart when divisionally performing calibration processing. If T1201<T902, the calibration processing shown in FIG. 9 cannot be performed at once. This corresponds to a case in which arithmetic processing to be performed is short, or the size of input image data is small. In this case, the calibration sequence shown in FIG. 9 is divisionally performed.

As described above, it is effective to perform calibration processing in a short period when the condition to perform calibration is satisfied. Hence, the image capturing apparatus 110 needs to complete calibration before the temperature largely changes by making the division count as small as possible. More specifically, the image capturing apparatus 110 determines the division count such that T902 can be ensured as many as possible during T1201. FIGS. 13A and 13B exemplarily show a case in which the division count is “2”. As shown in FIGS. 13A and 13B, during the periods T1201 of a plurality of arithmetic processing sequences, two divided delay value combinations (first to 128th data and 129th to 256th data) are performed. This makes it possible to perform calibration in a time as short as possible without stopping image analysis processing.

<Thinning in Calibration Processing>

A case in which calibration is divisionally performed has been described above. If the difference between T1201 and T902 is large, the division count is large. For this reason, if error determination is performed for the delay values of all patterns (M=256), the difference between the temperature at the start and the temperature at the end becomes large, and the effect of performing calibration lowers. In this case, it is effective to thin the patterns of delay values and perform the series of calibration sequences in a short time for some patterns (for example, N (N<M) patterns), as compared to divisionally performing processing for all the patterns of delay values.

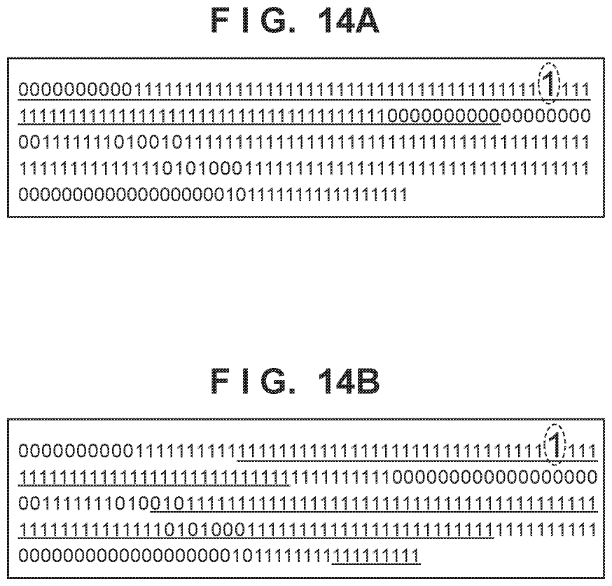

FIGS. 14A and 14B are views for explaining thinning processing of delay value patterns. FIGS. 14A and 14B are views for explaining two types of thinning methods. In FIGS. 14A and 14B, delay values used in calibration processing are indicated by underlines. That is, processing is thinned for delay values without underlines. A position surrounded by a broken line (“1” shown large) indicates the position of a delay value determined by the previously executed preceding calibration sequence.

FIG. 14A shows a case in which processes are performed as many as the count within T1201 from the delay value selected in the preceding calibration sequence. More specifically, FIG. 14A shows a case in which only the delay values of 100 patterns (N=100) with respect to the preceding delay value (51st delay value) as the center are used in calibration processing. This is effective thinning in a case in which the possibility that delay values do not largely change is high because, for example, no long time has elapsed from the preceding calibration sequence.

FIG. 14B shows a case in which a portion where “0” in error determination continues long in the preceding calibration sequence and portions on the periphery are thinned More specifically, FIG. 14B shows a case in which a portion where “0” determination continues for 10 or more values in the preceding error determination and 10 patterns on the periphery are thinned. The tendency of a portion where “0” continues intermittently is determined by the combination of the electric characteristics of the image capturing apparatus 110 and the detachable device 100. For this reason, this is effective thinning in a case in which delay value patterns should be found in a range as wide as possible because, for example, time has elapsed from the preceding calibration sequence.

Note that a general image capturing apparatus and a device complying with the SD standard hold a predetermined relationship between a host and a slave. For this reason, if a delay value cannot be determined as the result of calibration, calibration is performed a plurality of times. If a delay value cannot be determined yet, the frequency of the operation clock (CLK signal) is often lowered.

In this embodiment, the detachable device 100 need only comply with the SD standard. It is therefore possible to extend the mechanism of the standard to add a function to the side of the detachable device 100. In this case, when the delay value adjustment function is imparted to the detachable device 100 as well, the delay value can be adjusted at a resolution higher than a case in which calibration is performed only by the image capturing apparatus 110. As a result, communication can be continued while maintaining the frequency of the CLK signal. Even in such a configuration, if a delay value cannot be determined, clock adjustment of lowering the frequency of the CLK signal is performed. Note that the detachable device 100 is formed by a device capable of changing the circuit configuration later, like the FPGA 402. Hence, when the frequency of the CLK signal is lowered, it is preferable to rewrite the circuit configuration to that adapted to the frequency.

As described above, according to the first embodiment, calibration processing in the interface between the image capturing apparatus and the detachable device is performed during a period when the detachable device is performing processing without communication. This makes it possible to efficiently perform calibration without stopping processing that is being performed by the camera and the detachable device.

(Modifications)

In the above-described embodiment, image analysis processing has been described as an example of analysis processing. However, the disclosure is also applicable to audio analysis processing. More specifically, the disclosure is adaptable to processing of detecting an audio pattern such as a scream, a gunshot, or glass breaking sound. For example, a characteristic amount of an audio is extracted by various audio data analysis methods such as spectrum analysis, and it is compared with the detected audio pattern. By calculating the degree of matching, a specific audio pattern can be detected.

When performing audio analysis processing, audio data is divided into audio data of a predetermined time, audio analysis processing is performed using the audio data of the predetermined time as a unit. In addition, the predetermined time appropriately changes depending on the audio pattern of the detection target. For this reason, audio data of a time corresponding to an audio pattern to be detected is input to the detachable device 100. The detachable device 100 has a means for analyzing the input audio data or a means for holding the input audio data.

Also, in the above-described embodiment, the detachable device 100 capable of non-temporarily storing data input from the image capturing apparatus 110 has been described as an example. However, in some embodiments, the detachable device 100 that cannot non-temporarily store data input from the image capturing apparatus 110 may be used. That is, the detachable device 100 may only perform analysis processing for data input from the image capturing apparatus 110, and need not non-temporarily store the data. In other words, it may be the detachable device 100 that does not aim at storing data, like a normal SD card, but aims at only analysis processing.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-069267, filed Apr. 15, 2021, which is hereby incorporated by reference herein in its entirety.

What is claimed is:

1. An information processing apparatus comprising:
an interface circuit capable of attaching/detaching a detachable device; and
a control circuit configured to perform calibration processing of communication with the detachable device via the interface circuit,
wherein the control circuit performs the calibration processing during a period when the detachable device is performing predetermined processing without communication via the interface circuit.

2. The apparatus according to claim 1, wherein the calibration processing is processing of adjusting a phase relationship of a command signal and/or a data signal to a clock signal.

3. The apparatus according to claim 1, wherein the calibration processing is performed based on a data pattern generated by the detachable device.

4. The apparatus according to claim 1, further comprising a determination circuit configured to determine the predetermined processing based on information received from the detachable device and representing processing performable by the detachable device.

5. The apparatus according to claim 1, wherein the calibration processing includes processing of performing M data reception error determinations for M adjustment values that are different by a predetermined delay amount.

6. The apparatus according to claim 5, wherein if a period when the predetermined processing is being performed by the detachable device is longer than a period needed for the M data reception error determinations for the M adjustment values, the control circuit performs the M data reception error determinations for the M adjustment values in one period.

7. The apparatus according to claim 5, wherein if a period when the predetermined processing is being performed by the detachable device is shorter than a period needed for the M data reception error determinations for the M adjustment values, the control circuit divisionally performs the M data reception error determinations for the M adjustment values in a plurality of periods.

8. The apparatus according to claim 5, wherein if a period when the detachable device is performing the predetermined processing is shorter than a period needed for the M data reception error determinations for the M adjustment values, the control circuit performs, in one period, N (N<M) data reception error determinations for N adjustment values including an adjustment value determined in previously performed calibration processing.

9. The apparatus according to claim 5, wherein if a period when the detachable device is performing the predetermined processing is shorter than a period needed for the M data reception error determinations for the M adjustment values, the control circuit performs, in one period, N (N<M) data reception error determinations for N adjustment values except an adjustment value determined as error in previously performed calibration processing.

10. The apparatus according to claim 1, wherein if a communication error is detected during the communication with the detachable device via the interface circuit, the control circuit performs the calibration processing.

11. The apparatus according to claim 1, further comprising an information obtaining circuit configured to obtain temperature information of one of the information processing apparatus and the detachable device,
wherein if a temperature change of not less than a predetermined amount is detected in the temperature information obtained by the information obtaining circuit, the control circuit performs the calibration processing.

12. The apparatus according to claim 1, further comprising an information obtaining circuit configured to obtain processing time information in the detachable device,
wherein if it is detected that the processing time information obtained by the information obtaining circuit is not less than a predetermined time, the control circuit performs the calibration processing.

13. The apparatus according to claim 1, further comprising:
a clock adjustment circuit configured to lower an operation clock in the interface circuit if one adjustment value cannot be determined in the calibration processing by the control circuit; and
a transmission circuit configured to transmit, to the detachable device, configuration data that reconfigures a configurable arithmetic processing circuit provided in the detachable device so as to adapt to the lowered operation clock.

14. A method of controlling an information processing apparatus including an interface circuit capable of attaching/detaching a detachable device, comprising:
determining a period when the detachable device is performing predetermined processing without communication via the interface circuit; and
performing calibration processing of communication with the detachable device via the interface circuit in the determined period.
